(19) United States
(12) Patent Application Publication
(10) Pub. No.: US 2004/0006646 A1
(43) Pub. Date: Jan. 8, 2004

(54) Accumulation method for use in a collaborative working system

(75) Inventors: Carmine Cristallo, Roma (IT); Claudia Umani, Roma (IT); Federica Spiga, Roma (IT); Filomena Ferrara, Roma (IT)

Correspondence Address: Jeff Labaw, International Business Machines, Intellectual Property Law, 11400 Burnet Road, Austin, TX, 78758, US

(73) Assignee: INTERNATIONAL BUSINESS MACHNES CORPORATION, ARMONK, NY

(21) Appl. No.: 10/401,325

(22) Filed: Mar. 27, 2003

(30) Foreign Application Priority Data
Jun. 20, 2002 (EP) 02368060.6

(51) Int. Cl. G06F 15/16

(52) U.S. Cl. 709/248

(57) ABSTRACT

An accumulation method (400) for use in a collaborative working system (such as a remote control system) is proposed; this method is employed to identify regions (typically rectangles) of an image displayed on a target computer that are repeatedly updated, so as to transmit only the last update to a controller computer. In the solution of the invention, the updates are accumulated in a single rectangle. For each new rectangle, a total rectangle including both the new rectangle and the accumulated rectangle is determined (409). If the area of the total rectangle that is unaffected by the updates does not reach a threshold value (412-418), the accumulated rectangle is set (421) to the total rectangle; otherwise, the accumulated rectangle is transmitted (427-430) to the controller computer. The proposed method is not optimal in terms of minimizing the amount of data that is to be transmitted; however, this disadvantage is more than compensated for by the savings in processing time for accumulating the updates (being the computational complexity of the algorithm linear in the number of the processed rectangles).

### TECHNICAL FIELD

The present invention relates to the computer field, and more specifically to an accumulation method for use in a collaborative working system.

### BACKGROUND ART

The widespread diffusion of networks implementing distributed data processing systems, and in particular the INTERNET, has given rise to a new technology, generically referred to as collaborative working. In a collaborative working system, two or more computers operate simultaneously on a single application. For example, in a remote control system a controller computer manages a target computer remotely; for this purpose, an image displayed on the target computer must be replicated exactly on the controller computer.

A problem of the remote control systems (and more generally of any collaborative working system) is the limited bandwidth of the communication links used to connect the computers in the network. This bottleneck significantly affects the response time of the remote control system, and in particular increases the time required to replicate any update to the image on the target computer.

One way of coping with this problem is to transmit only the updates to the target computer rather than the whole image. Moreover, compression techniques are routinely used to reduce the amount of data that is to be transmitted on the network.

Accumulation algorithms have been also proposed for improving the effectiveness of the collaborative working systems. An accumulating algorithm identifies regions (typically rectangles) of the image displayed on the target computer that are repeatedly updated, so as to transmit only the last update to the controller computer. Known accumulation algorithms typically maintain a list of the rectangles that have been updated. Each new rectangle added to the list is tested against all the accumulated rectangles. If the new rectangle at least partially overlaps one or more of the pre-existing rectangles, these rectangles are removed from the list. Each removed rectangle is broken down into smaller rectangles not covered by the new rectangle, which smaller rectangles are then added to the list.

A drawback of the solution described above is that the computational complexity of the accumulation algorithm is proportional to the square of the number of accumulated rectangles. As a consequence, the savings in transmission time is very often not compensated for by the increased processing time required to the target computer. Moreover, the proliferation of rectangles reduces the effectiveness of the data compression, and increases the time required to display the updates on the controller computer.

This drawback is particular acute in situations wherein the overload of the target computer is critical. For example, the increased processing time required to the target computer is detrimental when the controller computer is used for debugging the target computer, or for controlling unattended applications running on the same. Moreover, the drawback is exacerbated when the target computer consists of old hardware components working at a low speed, or when the computers are connected in a (relatively) fast network (such as a Local Area Network, or LAN).

### SUMMARY OF THE INVENTION

It is an object of the present invention to improve the effectiveness of the collaborative working system.

It is another object of the present invention to save processing time for replicating images in the system.

It is yet another object of the present invention to reduce the computational complexity of the accumulation algorithm.

The accomplishment of these and other related objects is achieved by an accumulation method for use in a collaborative working system to replicate an image displayed on a first computer at a second computer connected to the first computer, the method including the steps under the control of the first computer of: detecting a current update in the content of the image, the update affecting a current region of a basic shape; verifying whether a union, resulting in a total region of the basic shape, between the current region and an accumulated region of the basic shape affected by previous updates still to be transmitted to the second computer meets a transmission condition; and transmitting the content of the accumulated region to the second computer if the result of the verification is positive, or setting the accumulated region to the total region otherwise.

The present invention also provides a computer program for performing the method and a product storing the program; moreover, a collaborative working application including the program and a product storing the application are encompassed. In addition, the invention provides a corresponding computer and a collaborative working system including the computer.

The novel features believed to be characteristic of this invention are set forth in the appended claims. The invention itself, however, as well as these and other related objects and advantages thereof, will be best understood by reference to the following detailed description to be read in conjunction with the accompanying drawings.

### BRIEF DESCRIPTION OF THE DRAWINGS

FIG. 1 is a schematic block diagram of a remote control system in which the accumulation method of the invention can be used;

FIG. 2 shows the main software components utilized for implementing the method;

FIG. 3 illustrates the general operation of the remote control system;

FIG. 4 is a flow chart describing the logic of the accumulation method;

FIGS. 5a-5c show an example of a remote control session.

### DETAILED DESCRIPTION OF THE PREFERRED EMBODIMENT

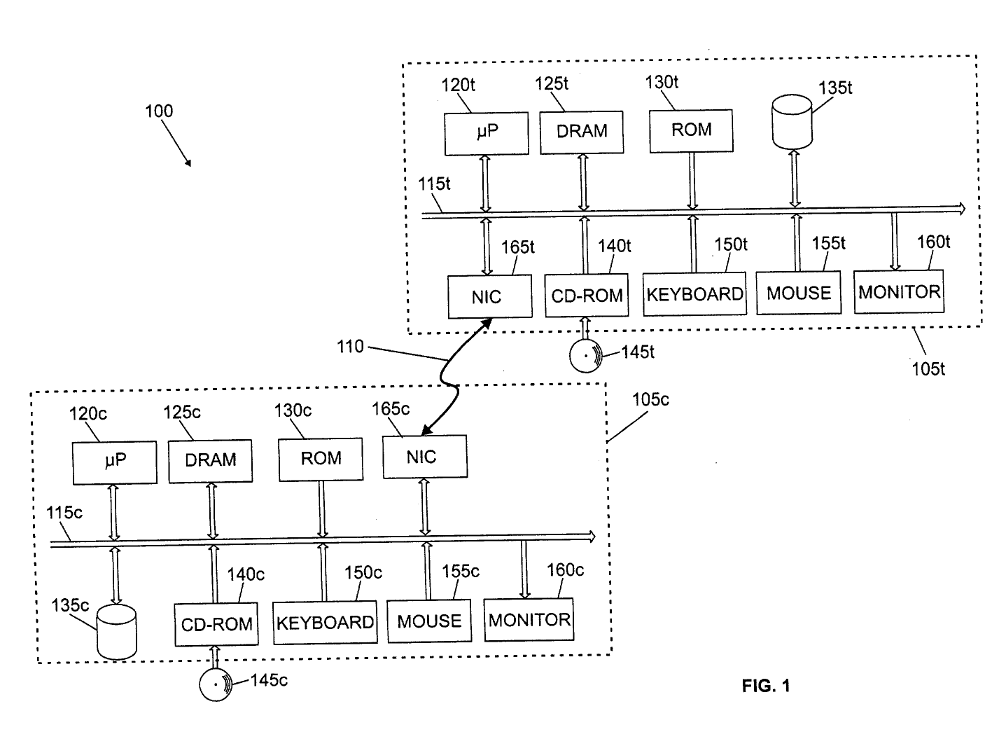

With reference in particular to FIG. 1, a remote control system 100 is illustrated. The system 100 includes two Personal Computers (PC) 105c and 105t, which are connected to each other through a network 110 (for example, the INTERNET). The computer 105t (referred to as a target computer) is under the complete control of the computer 105c (referred to as a controller computer). Particularly, the controller computer 105c is used to enter input information directly on the target computer 105t; at the same time, information output by the target computer 105t is replicated on the controller computer 105c. For all practical purposes, a user of the controller computer 105c operates on the target computer 105t as if he/she is sitting in front of it.

The target computer 105t is formed by several units that are connected in parallel to a communication bus 115t. In detail, a microprocessor (μP) 120t controls operation of the target computer 105t, a DRAM 125t is directly used as a working memory by the microprocessor 120t, and a Read Only Memory (ROM) 130t stores basic code for a bootstrap of the target computer 105t. Several peripheral units are further connected to the bus 115t (by means of respective interfaces). Particularly, a mass memory consists of a magnetic hard-disk 135t and a driver 140t for reading CD-ROMs 145t. Moreover, the target computer 105t includes input/output devices typically consisting of a keyboard 150t, a mouse 155t, and a monitor 160t. A network Interface Card (NIC) 165t is used to connect the target computer 105t to the network 110.

The controller computer 105c is likewise formed by a bus 115c, a microprocessor 120c, a working memory 125c, and a ROM 130c; the controller computer 105c further includes a hard-disk 135c, a driver 140c for CD-ROMs 145c, a keyboard 150c, a mouse 155c and a monitor 160c. A network interface card 165c is used to connect the controller computer 105c to the network 110.

Similar considerations apply if the computers are connected in a different manner (for example, through a LAN), if each computer is replaced with an equivalent data processing system (such as a mini-computer), if the computers have a different structure or include other units (for example, equivalent input and/or output devices), and the like. Alternatively, the system has more target computers (with the controller computer that alternatively takes the control of one of them) and/or more controller computers (with the target computer that is alternatively controlled by one of them).

Moreover, the proposed solution is applicable even in different collaborative working systems. For example, the method of the invention is used in an application sharing system, wherein two or more computers work simultaneously and in combination on a single application; in this case, the application runs on just one of the computers, but any update made to the application at each computer is mirrored on the other computers.

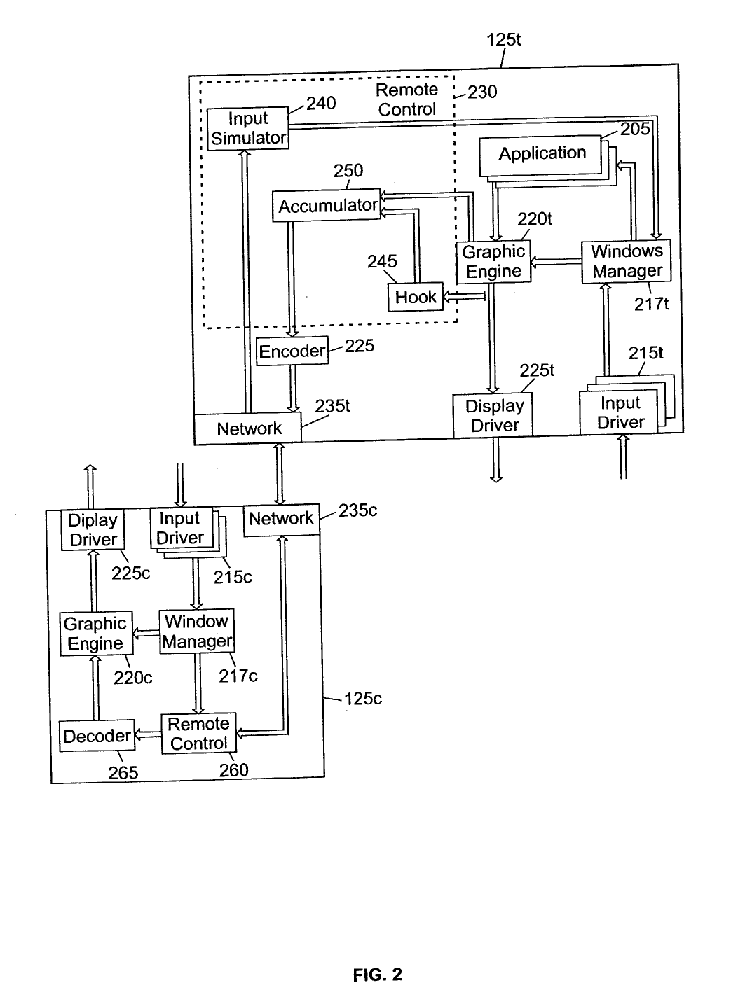

Considering now FIG. 2, a partial content of the working memory 125t of the target computer and a partial content of the working memory 125c of the controller computer are shown; the information (programs and data) is typically stored on the respective hard-disks and loaded (at least partially) into the working memories when the programs are running. The programs are initially installed onto the hard disks from CD-ROM.

Particularly, one or more application programs 205 are installed on the target computer. A user of the target computer enters commands and/or data (for each application program 205) using the keyboard or the mouse; any action performed by the user of the target computer generates an input command that is supplied to a respective input (keyboard or mouse) driver 215t. The driver 215t translates the input command into a standard format that is independent of the hardware characteristics of the input device; the resulting input command is then passed to a window manager 217t responsible for managing interaction of the user with the target computer. The window manager 217t provides a corresponding input instruction to the involved application program 205, unless the input command corresponds to an action (such as dragging a window) that is handled directly by the window manager 217t.

The application programs 205 and the window manager 217t supply output instructions to a graphic engine 220t. The graphic engine 220t calls a corresponding entry point in a display driver 225t, which performs the appropriate operations on an output buffer; the output buffer stores an image represented as a bit map (consisting of rows and columns of dots), which is accessed by the monitor of the target computer directly so as to display the image on its screen.

A program 230 implements the server side of an application providing a remote control facility for the target computer. For this purpose, the remote control server 230 is coupled with a stack 235t, which processes a set of protocol layers working together for defining network communication. Particularly, the remote control server 230 receives input messages indicative of input information entered on the controller computer remotely for the target computer; moreover, the remote control server 230 transmits output messages indicative of updates to the image displayed on the target computer that are to be replicated on the controller computer.

In detail, the input messages are supplied to a module 240, which simulates an equivalent action occurring at the target computer. For this purpose, the simulator 240 passes a corresponding input command to the window manager 217t (pretending to be the input driver 215t). A further module 245 intercepts the calls issued by the graphic engine 220t to the display driver 225t using a hooking technique. The hook 245 duplicates the calls and sends them to the display driver 225t (for updating the image displayed on the target computer) and to a still further module 250 (for replicating the update on the controller computer).

As described in detail in the following, the module 250 implements an accumulation algorithm. The accumulator 250 identifies regions of the image displayed on the target computer that are repeatedly updated (such as when a window is slowly dragged from one location to another). For these overlapping regions, only a last update is transmitted to the controller computer. As a consequence, the controller computer never receives the intervening updates; however, the missed updates are generally of little importance (as a matter of fact, they are very often not even perceived on the target computer). In any case, this is more than compensated for by the resulting reduction of the amount of data that is transmitted on the network. Whenever an accumulated update is to be transmitted to the controller computer, the accumulator 250 retrieves the content of the involved region of the image from the output buffer of the target computer (through the graphic engine 220t). The (accumulated) update is then compressed by an encoder 255, so as to reduce the amount of data required for its representation. A corresponding output message embedding the compressed update is then transmitted to the controller computer through the stack 235t.

The stack 235t communicates with a corresponding stack 235c installed on the controller computer. The stack 235c is coupled with a program 260, which implements the client side of the remote control application (cooperating with the server side 230 installed on the target computer). The remote control client 260 passes the output messages received from the target computer to a decoder 265; the decoder 265 decompresses the update to be replicated on the controller computer. Corresponding output instructions are then supplied to a graphic engine 220c, which controls a display driver 225c accordingly (so as to perform the appropriate operations on an output buffer for the monitor of the controller computer).

Any action performed by the user of the controller computer generates an input command that is supplied to a respective input driver 215c. The driver 215c controls a window manager 217t, which provides a corresponding input instruction to the remote control client 260 (unless the input command corresponds to an action that is handled directly by the window manager 217c through the graphic engine 220c). The remote control client 260 then generates an input message that is transmitted to the target computer (through the stack 235c).

Similar considerations apply if the remote control application is structured in a different manner, if different modules or functions are provided, if the hook is placed on the graphic engine rather than the display driver (even if this solution is slower and more difficult to implement), if the application programs are specially adapted for transmitting the output instructions both to the graphic engine and to the accumulator (even if this solution is not suitable for general use), and the like.

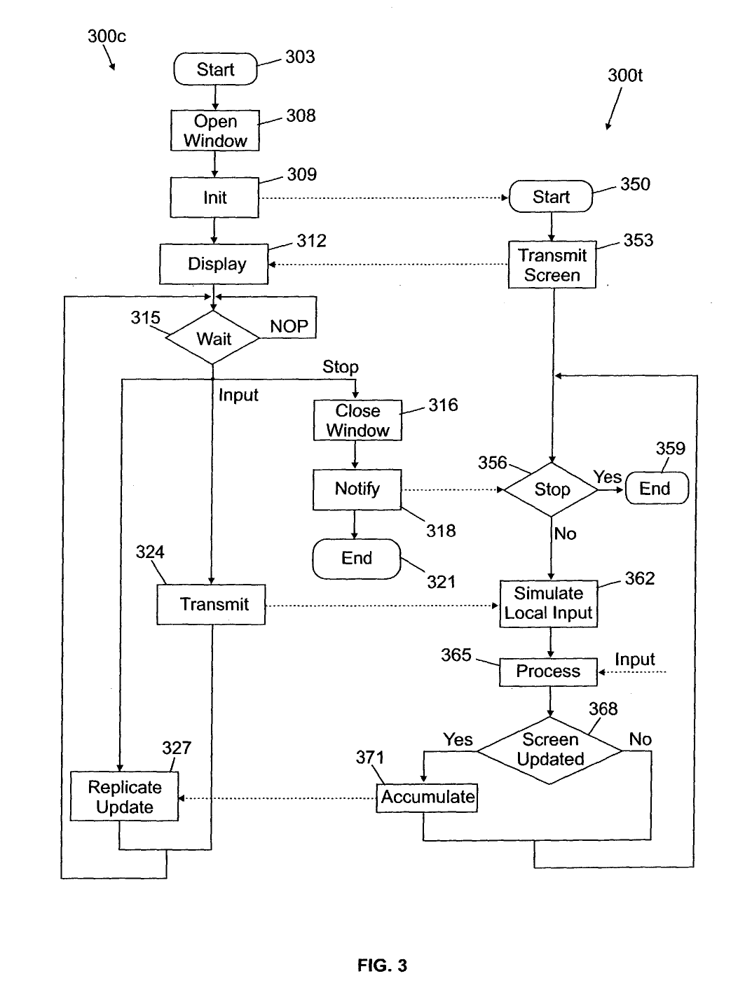

The operation of the remote control application is illustrated in FIG. 3. A remote control session is opened by a process 300c (blocks 303-327) running on the controller computer. The process 300c starts at block 303, and then passes to block 306 wherein a remote control window for replicating the image displayed on the target computer is created. Continuing to block 309, the remote control client initializes the session establishing a communication channel with the remote control server running on the target computer.

In response thereto, a further process 300t (blocks 350-371) is executed on the target computer. The process 300t starts at block 350, and then passes to block 353 wherein the whole image displayed on the target computer is transmitted to the controller computer. As soon as the image is received by the controller computer, it is replicated (as a simple bit map) in the remote control window at block 312.

The process 300c then enters an idle loop at block 315, waiting for an event to occur. If the user of the controller computer closes the remote control session, the corresponding window is destroyed at block 316 and the target computer is notified accordingly at block 318. The process 300c running on the controller computer then ends at the final block 321. On receipt of this notification (decision block 356), the process 300t running on the target computer ends at the final block 359 as well.

Referring back to block 315, whenever the user of the controller computer performs an action inside the remote control window the process 300c descends into block 324. The window manager of the controller computer is unaware of the content of the remote control window, so that it simply reports the action to the remote control client. The remote control client generates a corresponding input message, which is transmitted to the target computer; the process 300c then returns to block 315 waiting for a new event to occur. As soon as the input message is received by the target computer (block 362), the remote control server simulates an equivalent action occurring at the target computer. The corresponding input instruction is then processed on the target computer at block 365 (by the respective application program or by the window manager directly); the same result is achieved if the user of the target computer performs an action locally.

A test is then made at decision block 368 to determine whether the action resulted in an update of the image displayed on the target computer. If not, the process returns to block 356 for repeating the operations described above. Conversely, the update is accumulated at block 371 and the process then returns to block 356. Whenever the (accumulated) update is transmitted to the controller computer, the process 300c enters block 327. The update is replicated on the remote control window, and the process 300c then returns to block 315.

Similar considerations apply if the remote control application has an equivalent operative logic, if the remote control session is established in another way, if the image to be replicated on the controller computer takes only a portion of the screen on the target computer, and the like.

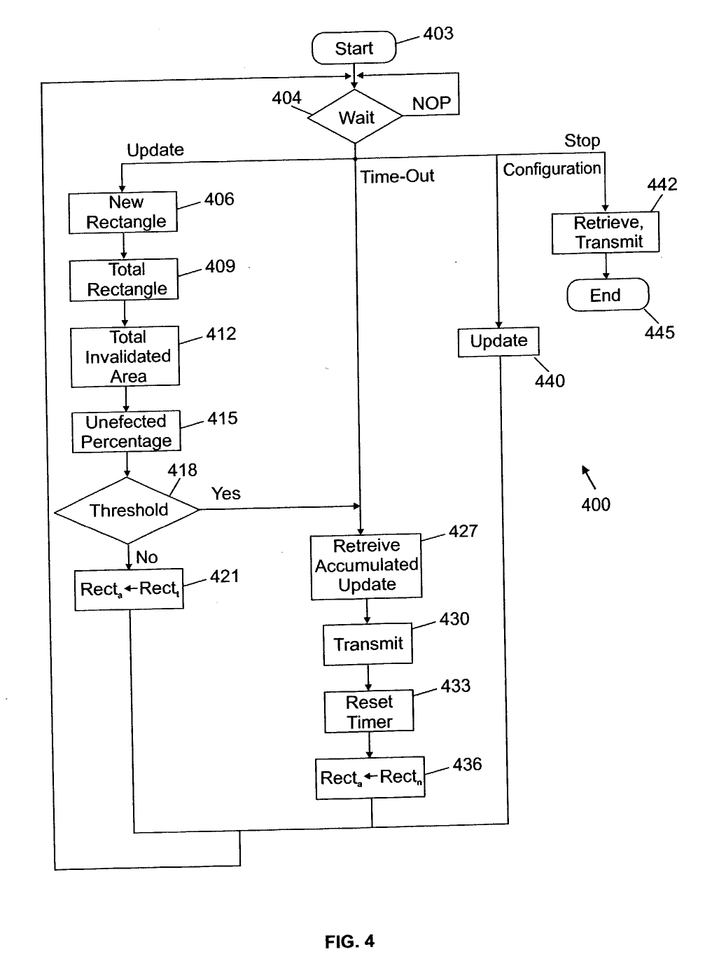

Moving now to FIG. 4, the accumulation algorithm implements a method 400 that starts at block 403, and then enters an idle loop at block 404 waiting for an event to occur. As soon as an update to the image displayed on the target computer is detected, the method passes to block 406. A new rectangle RECTn associated with the update is determined; the new rectangle RECTn represents the region of the image (not its content) that is affected by the intercepted call to the graphic engine. The most common calls are directly based on rectangles (for example, a rectangle of the image is deleted, copied, moved or coloured); for those calls that are not based on rectangles (such as drawing a polyline), a bounding rectangle is calculated. The new rectangle RECTn is generally indicated by two pairs of coordinates (for example, identifying its top left hand corner and its bottom right hand corner).

Proceeding to block 409, a total rectangle RECTt is determined; the total rectangle RECTt is defined as the smallest one including both the new rectangle RECTn and an accumulated rectangle RECTa associated with the updates still to be transmitted to the controller computer (set to an empty rectangle at the beginning). For example, if the new rectangle RECTn is arranged below and to the right of the accumulated rectangle RECTa, the total rectangle RECTt is identified by the top left hand corner of the accumulated rectangle RECTa and the bottom right hand corner of the new rectangle RECTn.

A value approximating the area INVt (expressed in number of dots) of the total rectangle RECTt actually invalidated by the updates is then obtained at block 412. The total invalidated area INVt is calculated adding the area of the new rectangle RECTn to the area of the accumulated rectangle RECTa, and then subtracting the area of their intersection (if any). For example, again assuming that the new rectangle RECTn is arranged below and to the right of the accumulated rectangle RECTa, the intersection region is identified by the top left hand corner of the new rectangle RECTn and the bottom right hand corner of the accumulated rectangle RECTa. The method then passes to block 415, wherein a percentage UNAFF of the area of the total rectangle RECTt unaffected by the updates is calculated. For this purpose, the total invalidated area INVt is subtracted from the area of the total rectangle RECTt; the result is then divided by the same area of the total rectangle RECTt.

A test is made in decision block 415 to determine whether the unaffected percentage UNAFF reaches a pre-set threshold value THp (for example, 30%). If not, the accumulated rectangle RECTa is set to the total rectangle RECTt (RECTa=RECTt) at block 421; at the same time, the content of the new rectangle RECTn is reset (to an empty region). The method then returns to block 404, waiting for a new event to occur.

Conversely, when the unaffected percentage UNAFF reaches the threshold value THp the accumulated update (consisting of the content of the accumulated rectangle RECTa) is retrieved from the output buffer of the target computer at block 427. The method continues to block 430, wherein the accumulated update is compressed and transmitted to the controller computer (so as to be replicated on its monitor). A timer TMR measuring the time elapsed from a last transmission of the accumulated update is reset at block 433. Proceeding to block 436, the accumulated rectangle RECTa is set to the new rectangle RECTn (RECTa=RECTn). The method then returns to block 404.

Considering again block 404, when the timer TMR reaches a pre-set time-out value THt (for example, 300 ms) the method enters block 427 directly. In this way, the steps 427-436 are executed as described above so as to transmit the accumulated update to the controller computer (with the accumulated rectangle RECTa that is reset to an empty region). The method then returns to block 404.

On the other end, when the user of the controller computer selects a configuration option (for example, in a pull-down menu of the remote control window), the method descends into block 440; the user of the controller computer updates the threshold value THp and/or the time-out value THt (defining a transmission condition for the accumulation algorithm as described above). The method then returns to block 404.

Conversely, when the remote control session has been closed the accumulated update is likewise retrieved, compressed and transmitted to the controller computer at block 442. The method then ends at the final block 445.

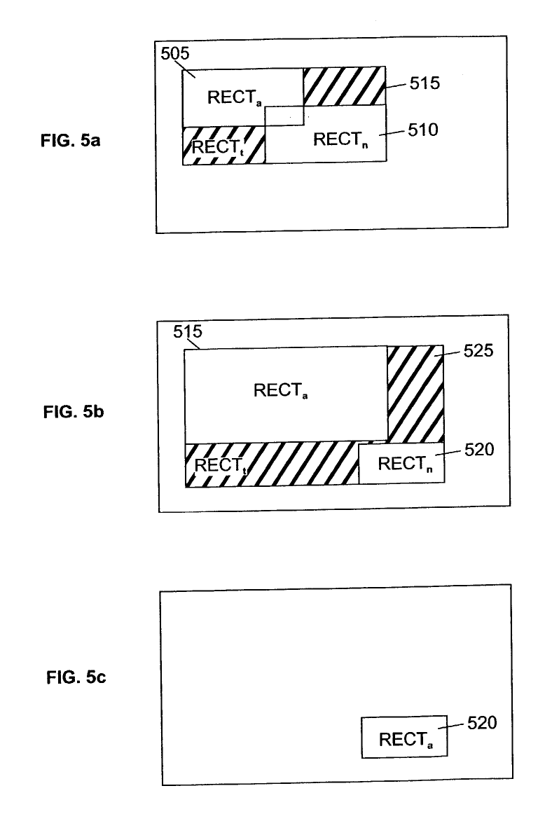

An example of a remote control session is illustrated in FIGS. 5a-5c. With reference in particular to FIG. 5a, an accumulated rectangle (RECTa) 505 and a new rectangle (RECTn) 510 represent corresponding updates on the screen of the target computer. A resulting total rectangle (RECTt) 515 is illustrated in dashed line; the area of the total rectangle 515 unaffected by the updates is crosshatched. Assuming that the transmission condition is not met (being the percentage of the unaffected area lower than the threshold value THp), the total rectangle 515 becomes the accumulated rectangle (RECTa) as shown in FIG. 5b. A further new rectangle (RECTn) 520 is then processed, resulting in a further total rectangle (RECTt) 525. In this case, the (crosshatched) area of the total rectangle 525 unaffected by the updates is very large (being the new rectangle 520 spaced apart from the accumulated rectangle 515). Therefore, the transmission condition is met and the new rectangle 520 becomes the accumulated rectangle (RECTa) as shown in FIG. 5c (after transmission of the content of the previous accumulated rectangle 515 to the controller computer).

Similar considerations apply if the accumulation algorithm performs an equivalent method (for example, with concurrent processes that execute the above described operations in parallel), if the extent of the total invalidated area is measured in another way, if the content of the new rectangle is transmitted to the controller computer when the transmission condition is met (even if this solution reduces the effectiveness of the accumulation algorithm), if the parameters defining the transmission condition are updated in a different manner (for example, upon initialising the remote control session), and the like.

More generally, the present invention proposes an accumulation method for use in a collaborative working system; the method allows an image, which is displayed on a first computer, to be replicated at a second computer connected to the first computer. The method involves a series of steps, which are performed under the control of the first computer. Particularly, a current update in the content of the image is detected; the update affects a current region of a basic shape. A test is carried out to verify whether a union, resulting in a total region of the basic shape, between the current region and an accumulated region of the basic shape affected by previous updates still to be transmitted to the second computer meets a transmission condition. The content of the accumulated region is then transmitted to the second computer if the result of the verification is positive; otherwise, the accumulated region is set to the total region.

The solution of the invention improves the effectiveness of the collaborative working system.

The proposed method is not optimal in terms of minimizing the amount of data that is to be transmitted for replicating the updates in the image. However, the resulting loss of performance is substantially insignificant in practice.

Anyway, this disadvantage is more than compensated for by the savings in processing time for accumulating the updates.

In fact, the computational complexity of the proposed algorithm is linear in the number of the processed updates.

Moreover, in the method of the invention the updates are accumulated in a single region of the basic shape (that is transmitted for replicating the image). This improves the effectiveness of the data compression (if any) performed on the corresponding data, and reduces the time required to display the updates (on the computer where they must be replicated).

The devised solution is particularly advantageous in situations wherein the overload in terms of processing time is critical (even if different applications are contemplated and within the scope of the present invention). For example, the resulting improvement is clearly perceived when a controller computer is used for debugging a target computer or for controlling unattended applications running on the same; this advantage is more apparent when the target computer consists of old hardware components working at a low speed, or when the computers are connected in a (relatively) fast network (such as a LAN).

The preferred embodiment of the invention described above offers further advantages.

For example, the accumulation algorithm processes rectangles.

This shape is computationally simple, and turns out to be very efficient for most applications (although more complicated descriptions of the updated regions, such as circles or polygons, could be used instead if so desired).

Advantageously, the accumulated update is transmitted to the target computer when a value indicative of an extent of the total rectangle unaffected by the current update and the previous updates reaches a threshold value.

This feature makes it possible to control the amount of data transmitted.

Preferably, the aforementioned verification is performed calculating a percentage of the area of the total rectangle that is not overlapped by the accumulated rectangle or the new rectangle.

The proposed technique has been found to provide a good approximation without requiring a substantial overload in terms of processing time.

As a further improvement, the accumulated update is always transmitted upon expiration of a time-out.

This ensures that updates occurring rarely or affecting regions that cannot be accumulated (for example, spaced apart in the image) are timely transmitted to the controller computer.

Preferably, the threshold value and/or the time-out may be updated (for example, by the user of the controller computer).

In this way, the accumulation algorithm is customized in a very simple manner, tuning its operation to different environment conditions (such as the speed of the target computer, the type of the graphic engine, or the structure of the network).

Alternatively, more sophisticated solutions are employed for calculating the unaffected percentage of the total rectangle (for example, taking into consideration the unaffected percentage of the accumulated rectangle as well), or the transmission condition is defined in a different way (for example, when the new rectangle and the accumulated rectangle do not overlap, or when their distance reaches a pre-set threshold value). Moreover, the solution according to the present invention leads itself to be implemented without any time-out (for example, transmitting the accumulated update periodically), or with the parameters defining the transmission condition that cannot be customized.

Advantageously, the solution according to the present invention is implemented with a computer program (software) application, which is provided on CD-ROM. The application has a client-server architecture; particularly, it consists of a first program (for example, installed on a target computer) and a second program (for example, installed on a controller computer); moreover, it should be noted that the first program is suitable to be implemented separately and put on the market even as a stand-alone product, in order to be used in pre-existing collaborative working systems.

Alternatively, the application is provided on floppy-disk, is pre-loaded onto the hard-disks, or is stored on any other computer readable medium, is sent to the computers through the network, is broadcast, or more generally is provided in any other form directly loadable into the working memories of the computers. However, the method according to the present invention leads itself to be carried out with an application having a different architecture, and even with a hardware structure (for example, integrated in one or more chips of semiconductor material).

Naturally, in order to satisfy local and specific requirements, a person skilled in the art may apply to the solution described above many modifications and alterations all of which, however, are included within the scope of protection of the invention as defined by the following claims.

1. An accumulation method (400) for use in a collaborative working system to replicate an image displayed on a first computer at a second computer connected to the first computer, the method including the steps under the control of the first computer of:
detecting (406) a current update in the content of the image, the update affecting a current region of a basic shape,
characterized by the steps of
verifying (409-418) whether a union, resulting in a total region of the basic shape, between the current region and an accumulated region of the basic shape affected by previous updates still to be transmitted to the second computer meets a transmission condition, and
transmitting (427-430) the content of the accumulated region to the second computer if the result of the verification is positive, or setting (421) the accumulated region to the total region otherwise.

2. The method (400) according to claim 1, wherein the basic shape is a rectangle (505-520).

3. The method (400) according to claim 1 or 2, wherein the step of verifying (409-418) whether the union meets the transmission condition includes:
calculating (412-415) a comparison value indicative of an extent of the total region unaffected by the current update and the previous updates, and
verifying (418) whether the comparison value reaches a threshold value.

4. The method (400) according to claim 3, wherein the step of calculating (412-415) the comparison value includes:
calculating (412) a non-overlapped area of the total region not overlapped by the accumulated region or the current region, and
calculating (415) a percentage of the non-overlapped area with respect to an area of the total region.

5. The method (400) according to any claim from 1 to 4, further including the step of transmitting (427-430) the content of the accumulated region to the second computer when the time elapsed from a last transmission of the content of the accumulated region reaches a further threshold value.

6. The method (400) according to claim 5, further including the step of updating (440) the threshold value or the further threshold value.

7. A computer program (230) directly loadable into a working memory of a computer (105t) for performing the method of any claim from 1 to 6 when the program is run on the computer.

8. A program product (145t) comprising a computer readable medium on which the program (230) of claim 7 is stored.

9. A collaborative working application (230,260) including the computer program (230) of claim 7 and a further computer program (260) directly loadable into a working memory of a further computer (105c) connected to the computer (105t), the computer program and the further computer program cooperating to perform a method (300t,300c) of replicating an image displayed on the computer at the further computer.

10. A program product (145t,145c) comprising a computer readable medium on which the program application (230,260) of claim 9 is stored.

11. A computer (105t) for use in a collaborative working system (100) to replicate an image displayed on the computer at a further computer (105c) connected to the computer, the computer including means (245) for detecting a current update in the content of the image, the update affecting a current region of a basic shape,
characterized in that
the computer further includes means (250) for verifying whether a union, resulting in a total region of the basic shape, between the current region and an accumulated region of the basic shape affected by previous updates still to be transmitted to the further computer meets a transmission condition, and means (250) for transmitting the content of the accumulated region to the further computer if the result of the verification is positive or for setting the accumulated region to the total region otherwise.

12. A collaborative working system (100) including the computer (105t) of claim 11, a further computer (105c), means (110) for connecting the further computer to the computer, and means (230,260) for replicating an image displayed on the computer at the further computer.
